(19) United States
(12) Patent Application Publication
(10) Pub. No.: US 2025/0372677 A1
(43) Pub. Date: Dec. 4, 2025

(54) Fuel Cell Vehicle and Method of Controlling Same

(71) Applicants: Hyundai Motor Company, Soeul (KR); Kia Corporation, Seoul (KR)

(72) Inventor: Jae Nam Lim, Hwaseong-Si (KR)

(21) Appl. No.: 18/947,918

(22) Filed: Nov. 14, 2024

(30) Foreign Application Priority Data
May 29, 2024 (KR) 10-2024-0070306

(51) Int. Cl. H01M 8/043; B60L 50/75; B60L 58/30; G07C 5/10; H01M 8/04119; H01M 8/0432; H01M 8/0438; H01M 8/04492; H01M 8/04537; H01M 8/04701; H01M 8/04746; H01M 16/00

(52) U.S. Cl. CPC H01M 8/043; B60L 50/75; B60L 58/30; G07C 5/10; H01M 8/04126; H01M 8/0432; H01M 8/04395; H01M 8/04507; H01M 8/04626; H01M 8/04701; H01M 8/04753; H01M 16/006; B60L 2240/62; H01M 2220/20; H01M 2250/20

(57) ABSTRACT

A method of controlling a fuel cell vehicle includes determining whether a fuel cell stack is in a dry state based on relative humidity of supplied air depending on an operating temperature of the fuel cell stack or whether a battery of the vehicle is expected to be overcharged while the vehicle equipped with the fuel cell stack and the battery connected to the fuel cell stack is traveling, and switching a driving mode of the vehicle to a durability improvement mode in which at least one of the operating temperature of the fuel cell stack or an air flow rate supplied to the fuel cell stack is controlled if the fuel cell stack is in a dry state or the battery is expected to be overcharged as a result of the determination.

### CROSS-REFERENCE TO THE RELATED APPLICATION

This application claims priority from Korean Patent Application No. 10-2024-0070306, filed on May 29, 2024 in the Korean Intellectual Property Office, the disclosure of which is incorporated herein by reference in its entirety.

### TECHNICAL FIELD

The present disclosure relates to a method of controlling a fuel cell vehicle equipped with a fuel cell stack and a battery to improve fuel cell durability during driving in a dry environment and a speed limit zone.

### BACKGROUND

Fuel cell vehicles improve fuel efficiency and power performance by providing driving force to a motor using energy produced by a fuel cell stack and a high-voltage battery that stores the remaining energy to be consumed by the motor.

State of Charge (SoC) overcharging of a battery connected to the fuel cell stack due to a speed limit in a speed limit zone (e.g., child protection zone) may cause cancellation of an upper voltage limit. The cancellation of the upper voltage limit may limit regenerative breaking and/or accelerate deterioration of the fuel cell stack.

If the air outside a vehicle is dry, the relative humidity of the air entering the fuel cell stack is low, which may cause the fuel cell stack to become dry, which has a negative effect on the durability of the fuel cell stack.

The matters described as background technology above are only for the purpose of improving understanding of the background of the present disclosure and should not be taken as recognition that they correspond to prior art already known to those skilled in the art.

### SUMMARY

The following summary presents a simplified summary of certain features. The summary is not an extensive overview and is not intended to identify key or critical elements.

Systems, apparatuses, and methods are described for a fuel cell vehicle. A method may comprise: while a vehicle, equipped with a fuel cell stack and a battery associated with the fuel cell stack, is traveling, determining, by a control device of the vehicle, one or more of: that the fuel cell stack is in a dry state based on relative humidity of supplied air depending on an operating temperature of the fuel cell stack, or that the battery associated with the fuel cell stack is expected to be overcharged; and switching, based on the determining, a driving mode of the vehicle to a durability improvement mode in which at least one of the operating temperature of the fuel cell stack or an air flow rate supplied to the fuel cell stack is controlled to a target value.

Also, or alternatively, a fuel cell vehicle may comprise: a fuel cell stack; a battery connected to the fuel cell stack; and a performance improvement device comprising: one or more processors; and memory storing instructions. The instructions, when executed by the one or more processors, configure the performance improvement device to: determine, while the vehicle is traveling, one or more of: that the fuel cell stack is in a dry state based on relative humidity of supplied air depending on an operating temperature of the fuel cell stack, or that the battery is expected to be overcharged; and switch, based on the fuel cell stack being in the dry state or on the battery being expected to be overcharged, a driving mode of the vehicle to a durability improvement mode in which at least one of the operating temperature of the fuel cell stack or an air flow rate supplied to the fuel cell stack is controlled to a target value.

These and other features and advantages are described in greater detail below.

### BRIEF DESCRIPTION OF THE DRAWINGS

FIG. 1 is a diagram illustrating a configuration of a fuel cell vehicle according to an example of the present disclosure.

FIG. 2 is a diagram schematically illustrating a performance improvement device according to an example of the present disclosure.

FIG. 3 is a flowchart for describing a method of controlling a fuel cell vehicle according to an example of the present disclosure.

FIG. 4 is a diagram for describing an operation of determining whether a fuel cell stack is in a dry state according to an example of the present disclosure.

FIG. 5 and FIG. 6 are diagrams for describing an operation of determining whether a vehicle battery is expected to be overcharged according to an example of the present disclosure.

### DETAILED DESCRIPTION OF THE PREFERRED EXAMPLES

In the following description, detailed descriptions of known functions and configurations will be omitted if such detailed descriptions may obscure the subject matter of the present disclosure. Also, the accompanying drawings are provided only for ease of understanding of the examples disclosed herein, and do not limit the technical spirit disclosed herein. The drawings represent all changes, equivalents and substitutes included in the spirit and scope of the present disclosure.

The terms “first” and/or “second” are used to describe various components, but such components are not limited by these terms. The terms are used to discriminate one component from another component.

If a component is “coupled” or “connected” to another component, it should be understood that a third component may be present between the two components although the component may be directly coupled or connected to the other component. If a component is “directly coupled” or “directly connected” to another component, it should be understood that no element is present between the two components.

An element described in the singular form is intended to include a plurality of elements unless the context clearly indicates otherwise.

In the present disclosure, it will be further understood that the term “comprise” or “include” specifies the presence of a stated feature, figure, step, operation, component, part or combination thereof, but does not preclude the presence or addition of one or more other features, figures, steps, operations, components, or combinations thereof.

The suffixes “module” and “unit” of elements used in the following description are used for convenience of description and thus can be used interchangeably and do not have any distinguishable meanings or functions.

Hereinafter, examples disclosed in the present disclosure will be described in detail with reference to the attached drawings. However, identical or similar components will be assigned the same reference numeral, and redundant descriptions thereof will be omitted.

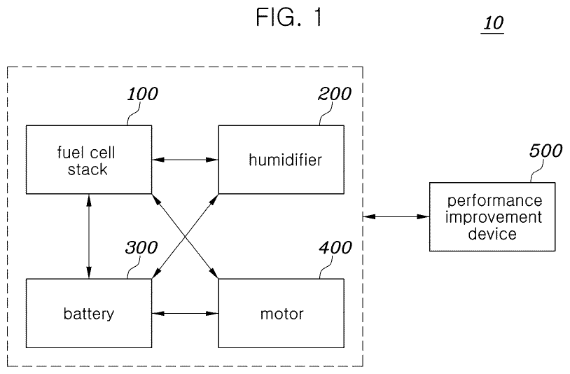

First, a fuel cell vehicle according to an example of the present disclosure will be described with reference to FIG. 1.

FIG. 1 is a diagram illustrating the configuration of the fuel cell vehicle according to an example of the present disclosure.

Referring to FIG. 1, the fuel cell vehicle 10 may include a fuel cell stack 100, a battery 300, and a performance improvement device 500. However, FIG. 1 mainly shows components related to an example of the present disclosure, and fewer or more components may be included if implementing an actual fuel cell vehicle. For example, as illustrated in FIG. 1, the fuel cell vehicle 10 may be configured to further include a humidifier 200 and a motor 400.

The fuel cell vehicle 10 may determine a dry state of the fuel cell stack 100 and an expected overcharge state of the battery 300 while traveling in a speed limit zone or a congested area and control the operating temperature or air flow rate of the fuel cell stack 100.

The fuel cell vehicle 10 according to an example of the present disclosure may mean a vehicle (fuel cell electric vehicle (FCEV)) driven by the energy of a fuel cell.

Hereinafter, each component of the fuel cell vehicle 10 will be described.

The fuel cell stack 100 may be configured to produce electrical energy by electrochemically reacting fuel and an oxidant. For example, the fuel cell stack 100 may be implemented as a hydrogen fuel cell stack, and may be configured to produce electrical energy through an electrochemical reaction between hydrogen supplied from a hydrogen storage tank (not shown) and oxygen in the air supplied through the humidifier 200.

The fuel cell stack 100 may transmit the produced energy to the motor 400 and/or the battery 300.

The humidifier 200 may be configured to supply moist air to the fuel cell stack 100 using external air of the vehicle 10 and produced water supplied from the fuel cell stack 100.

The humidifier 200 may control the air flow rate supplied to the fuel cell stack 100.

The battery 300 may provide electrical energy to the motor 400 and may store electrical energy supplied from the fuel cell stack 100. For example, the battery 300 may be implemented as a high-voltage battery.

The motor 400 may provide driving force to the vehicle through the electrical energy supplied from the fuel cell stack 100 and/or the battery 300.

The performance improvement device 500 may be configured to improve the durability of the fuel cell stack 100 and prevent deterioration of the fuel cell stack 100 by determining a dry state of the fuel cell stack 100 and an expected overcharge state of the battery 300 while the vehicle is traveling in a speed limit zone or a congested area and controlling the operating temperature or air flow rate of the fuel cell stack 100.

The performance improvement device 500 may preemptively control the operating temperature or air flow rate of the fuel cell stack 100 (e.g., if the vehicle 10 enters or exits a speed limit zone and/or a congested area, as may be determined using navigation information), which may improve durability and/or prevent deterioration.

Also, or alternatively, the performance improvement device 500 takes into account the flooding problem of the fuel cell stack 100 if controlling the operating temperature or air flow rate of the fuel cell stack 100, and thus it is possible to prevent performance reduction of the fuel cell vehicle 10 in various manners by considering both the dry state and the flooding state.

Also, or alternatively, the performance improvement device 500 controls the operating temperature or air flow rate of the fuel cell stack 100 in consideration of the acceleration state of the vehicle 10 if the vehicle 10 exits a speed limit zone or a congested area, thereby preventing insufficient power due to sudden power demand during low temperature driving and low flow rate driving and obtaining the effects of improving the durability of the fuel cell stack 100 and preventing deterioration of the fuel cell stack 100.

The performance improvement device 500 may determine whether the fuel cell stack 100 is in a dry state and/or the battery 300 is expected to be overcharged, which is determined based on the relative humidity of the supply air according to the operating temperature of the fuel cell stack 100 of the vehicle 10.

Also, or alternatively, the performance improvement device 500 may switch the driving mode of the vehicle 10 to a durability improvement mode in which the operating temperature of the fuel cell stack 100 or the air flow rate supplied to the fuel cell stack 100 is controlled according to determination.

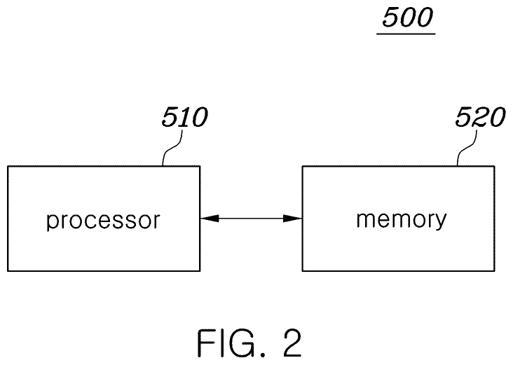

Hereinafter, the performance improvement device 500 according to an example of the present disclosure will be described in detail with reference to FIG. 2.

FIG. 2 is a diagram schematically illustrating the performance improvement device according to an example of the present disclosure.

Referring to FIG. 2, the performance improvement device 500 includes a processor 510 and a memory 520. The processor 510 may include one or more processors, which may include one or more of a central processing unit, an application processor, or a communication processor.

The processor 510 may perform operations or data processing related to control of one or more other components of the performance improvement device 500. For example, the processor 510 may execute applications and/or software stored in the memory 520.

The processor 510 may process received data and data stored in the memory 520. The processor 510 may process data stored in the memory 520. The processor 510 may execute computer-readable code (e.g., software) stored in the memory 520 and instructions triggered by the processor 510. The instructions, when executed by the processor 510, may configure the performance improvement device to perform one or more of the methods described herein.

The processor 510 may be a data processing device implemented as hardware including a circuit having a physical structure for executing desired operations. For example, the desired operations may include code or instructions included in programs.

For example, data processing devices implemented as hardware may include a microprocessor, a central processing unit, a processor core, a multi-core processor, a multiprocessor, an application-specific integrated circuit (ASIC), and a field programmable gate array (FPGA).

The processor 510 may receive navigation information of vehicle 10 and/or information on the air outside the vehicle 10.

The processor 510 may determine whether the fuel cell stack 100 is in a dry state and/or whether the battery 300 is expected to be overcharged, which is determined based on the relative humidity of supplied air according to the operating temperature of the fuel cell stack 100 of the vehicle 10.

For example, the processor 510 may determine whether the fuel cell stack 100 is in a dry state and/or the battery 300 is expected to be overcharged in a speed limit zone or a congested area if the vehicle 10 enters the speed limit zone or the congested area according to (e.g., based on) navigation information. A speed limit zone may refer to a section where a vehicle driving speed should not exceed a certain speed, and a congested area may refer to a section where a vehicle driving speed does not exceed a certain speed or is maintained at a low level due to vehicle congestion over a certain distance. However, this is an example and the present disclosure is not necessarily limited thereto.

For example, the processor 510 may determine whether the fuel cell state 100 is in a dry state by comparing the current relative humidity derived from the total amount of water vapor supplied from the humidifier 200 provided in the fuel cell stack 100 and the saturated water vapor amount depending on the current operating temperature of the fuel cell stack 100 with a preset dry relative humidity.

The processor 510 may calculate a first amount of water vapor supplied to the humidifier 200 from the outside of the vehicle 10 using the saturated water vapor amount according to the temperature of the air outside the vehicle 10 and the relative humidity of the air outside the vehicle 10.

The processor 510 may calculate a second amount of water vapor supplied from the humidifier 200 using the produced water supplied to the humidifier 200 from the fuel cell stack 100, the humidification efficiency of the humidifier 200, and the total amount of air supplied to the humidifier 200.

For example, the total amount of air supplied to the humidifier 200 may be calculated using the theoretical air amount and stoichiometric ratio (SR) required by the fuel cell stack 100.

The processor 510 may calculate the current relative humidity using the first amount of water vapor supplied to the humidifier 200 from the outside of the vehicle, the second amount of water vapor from the humidifier 200, and the saturated water vapor amount according to the current operating temperature of the fuel cell stack 100.

The processor 510 may determine the fuel cell stack 100 to be in a dry state if the current relative humidity is below the preset dry relative humidity.

For example, the processor 510 may determine whether the battery 300 is expected to be overcharged by comparing expected charging energy to be stored in the battery 300 and the current charging energy of the battery 300 in a speed limit zone or congested area with the total energy that can be charged by the battery 300.

The processor 510 may calculate the energy produced by the fuel cell stack 100 and driving energy used by the motor 400 in a speed limit zone or a congested area using the speed limit of the speed limit zone or the congestion area and the total driving distance of the speed limit zone or the congested area included in navigation information. For example, the processor 510 may calculate the produced energy and the driving energy by considering if the vehicle 10 travels the total driving distance of the speed limit zone or the congested area at the speed limit.

The processor 510 may calculate expected charging energy to be stored in the battery 300 using the produced energy and the driving energy.

The processor 510 may determine that the battery 300 is expected to be overcharged if the sum of the current charging energy and the expected charging energy of the battery 300 is greater than or equal to the total energy of the battery 300.

The processor 510 may switch the driving mode to the durability improvement mode in which the operating temperature of the fuel cell stack 100 or the air flow rate supplied to the fuel cell stack 100 is controlled according to whether the fuel cell stack 100 is in a dry state or whether the battery 300 is expected to be overcharged.

For example, if the processor 510 determines the dry state and the expected overcharge state as a result of determining whether the fuel cell stack 100 is in a dry state or the battery 300 is expected to be overcharged, the processor 510 may determine a target operating temperature of the fuel cell stack 100 using at least one of the total driving time for which the vehicle 100 travels in a speed limit zone or a congested area, the current operating temperature, the total amount of heat required to cool the fuel cell stack 100 to the target operating temperature in the speed limit zone or the congested area, energy per unit time required for a coolant circulating through the fuel cell stack 100 to cool the fuel cell stack 100, or heat energy generated from the fuel cell stack 100. For example, the processor 510 according to an example of the present disclosure may determine the target operating temperature for the fuel cell stack 100 by considering all the aforementioned factors.

Also, or alternatively, the processor 510 may determine a target air flow rate supplied to the fuel cell stack 100 using the target operating temperature of the fuel cell stack 100, the first amount of water vapor supplied to the humidifier 200 from the outside of the vehicle 10, produced water supplied from the fuel cell stack 100 to the humidifier 200, the humidification efficiency of the humidifier 200, the theoretical air amount required by the fuel cell stack 100, and the preset dry relative humidity.

For example, the processor 510 may determine a target relative humidity based on at least one of the saturated water vapor amount according to the target operating temperature of the fuel cell stack 100, the first amount of water vapor supplied to the humidifier 200 from the outside of the vehicle 10, the produced water supplied from the fuel cell stack 100 to the humidifier 200, the humidification efficiency of the humidifier 200, and the theoretical air amount. For example, the processor 510 according to an example of the present disclosure may determine the target relative humidity by considering all the aforementioned factors. Additionally, the processor 510 may determine a target air flow rate at which the determined target relative humidity satisfies the preset dry relative humidity or more.

As described herein, the processor 510 may determine the target operating temperature or the target air flow rate, and control the operating temperature of the fuel cell stack 100 or the air flow rate supplied to the fuel cell stack 100 according to the determined target operating temperature or target air flow rate.

The processor 510 may determine whether to maintain or disable the durability improvement mode.

For example, the processor 510 may calculate previous cell deviation with respect to the cells included in the fuel cell stack 100 before switching to the durability improvement mode and current cell deviation with respect to the cells included in the fuel cell stack 100 after switching to the durability improvement mode.

The processor 510 may receive minimum voltages, maximum voltages, and mean voltages of the cells included in the fuel cell stack 100. Accordingly, the processor 510 may determine (e.g., calculate) the previous cell deviation using a first minimum voltage, a first maximum voltage, and a first mean voltage of the cells included in the fuel cell stack 100 before switching to the durability improvement mode. Additionally, the processor 510 may determine (e.g., calculate) the current cell deviation using a second minimum voltage, a second maximum voltage, and a second mean voltage of the cells included in the fuel cell stack 100 after switching to the durability improvement mode.

The processor 510 may determine whether the fuel cell stack 100 is in a flooding state using the current operating temperature of the fuel cell stack 100, the target operating temperature of the fuel cell stack 100, the calculated previous cell deviation, and the calculated current cell deviation.

The processor 510 may disable the durability improvement mode or maintain the durability improvement mode based on the result of determination of a flooding state. For example, the processor 510 may disable the durability improvement mode if the fuel cell stack 100 is in a flooding state and/or may maintain the durability improvement mode if the fuel cell stack 100 is not in a flooding state.

The processor 510 may determine whether the vehicle 10 has entered an acceleration situation based on expected charging energy to be stored in the battery 300, and disable or maintain the durability improvement mode depending on whether a driving time according to entering the acceleration situation is satisfied.

For example, the processor 510 may determine the expected charging energy to be stored in the battery 300 and determine whether the vehicle 10 has entered an acceleration situation based on the determined expected charging energy. For example, if the expected charging energy is less than 0, the processor 510 may determine that the vehicle 10 has entered an acceleration situation.

Additionally, the processor 510 may determine a possible driving time of the vehicle 10 based on the battery 300 based on the expected charging energy and the current charging energy of the battery 300. The processor 510 may disable or maintain the durability improvement mode by comparing an expected driving time based on the vehicle 10 entering an acceleration situation with the determined possible driving time.

If expected charging energy is less than 0, it may mean that energy is used rather than being stored in the battery 300. In other words, in this case, the expected charging energy may refer to discharge energy required if the vehicle 10 enters an acceleration situation. The required discharge energy may be provided by the battery 300, and the time required to consume the current charging energy of the battery 300 based on the required discharge energy may be a possible driving time. However, this is an example and the present disclosure is not necessarily limited thereto.

The processor 510 may disable the durability improvement mode if the expected driving time is longer than or equal to the possible driving time and/or may maintain the durability improvement mode if the expected driving time is less than the possible driving time.

Additionally, the processor 510 may determine whether the vehicle 10 has exited a speed limit zone or a congested area according to received navigation information, and may disable the durability improvement mode if the vehicle 10 has exited a speed limit zone or a congested area.

The memory 520 may include a volatile memory and/or a non-volatile memory.

The memory 520 may store instructions and/or data related to one or more other components of performance improvement device 500.

The memory 520 may store software and/or programs. For example, the memory 520 may store applications and software for improving fuel cell durability.

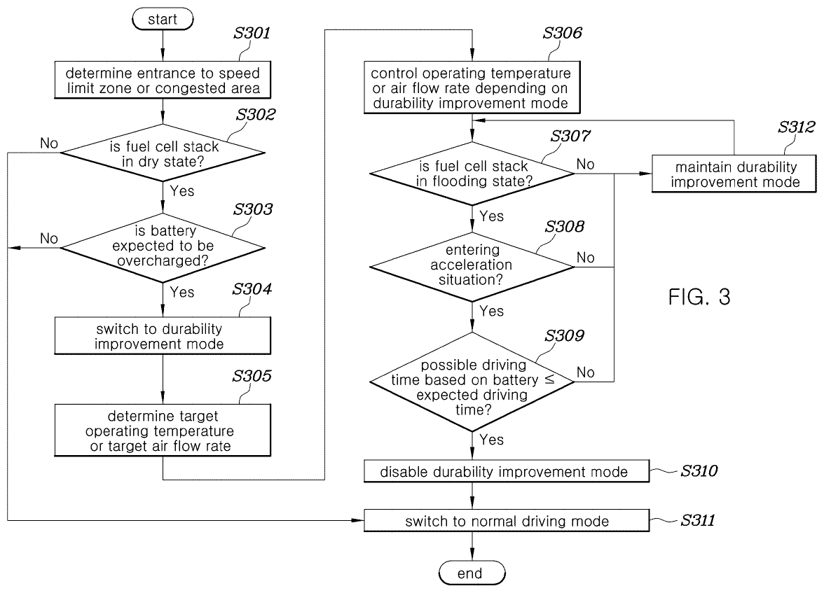

Hereinafter, a method of controlling a fuel cell vehicle according to an example of the present disclosure will be described with reference to FIG. 3 to FIG. 6 based on the fuel cell vehicle described with reference to FIG. 1 and FIG. 2. Each step of the method of controlling a fuel cell vehicle should be understood as being performed by the performance improvement device 500 described with reference to FIG. 1 and FIG. 2.

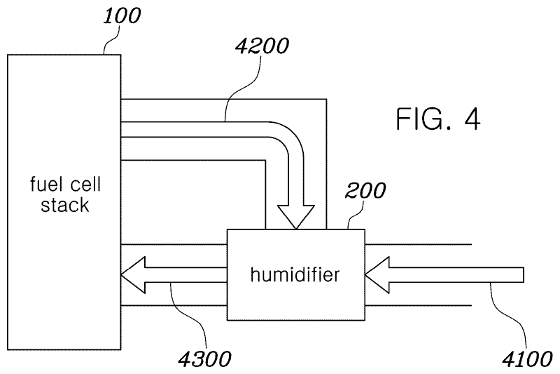

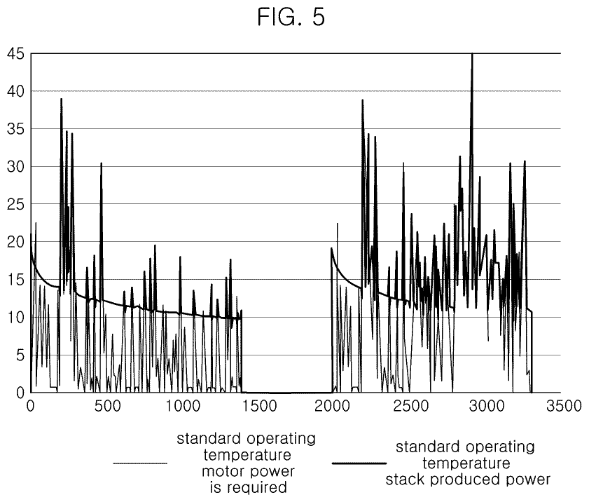

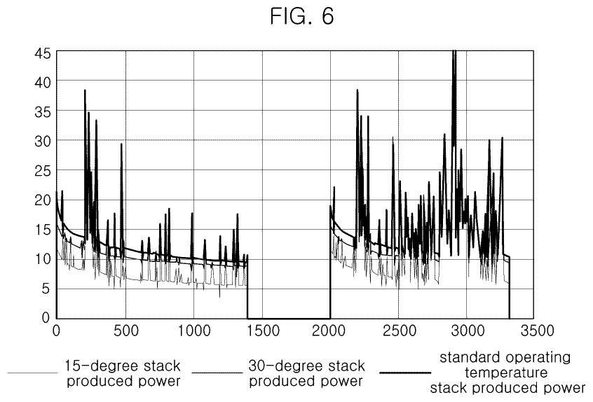

FIG. 3 is a flowchart for describing a method of controlling a fuel cell vehicle, FIG. 4 is a diagram for describing an operation of determining whether a fuel cell stack is in a dry state according to an example of the present disclosure, and FIG. 5 and FIG. 6 are diagrams for describing an operation of determining whether a vehicle battery is expected to be overcharged according to an example of the present disclosure.

First, referring to FIG. 3, the performance improvement device 500 may receive navigation information of the vehicle 10 and/or information on the air outside the vehicle 10 to determine whether the vehicle has entered a speed limit zone or a congested area (S301).

Also, or alternatively, the performance improvement device 500 may determine whether the fuel cell stack 100 is in a dry state, which is determined by the relative humidity of supplied air depending on the operating temperature of the fuel cell stack 100 of the vehicle 10 (S302). Also, or alternatively, the performance improvement device 500 may determine whether the fuel cell stack 100 is in a dry state in a speed limit zone or a congested area zone if the vehicle 10 enters the speed limit zone or the congested area according to the navigation information.

The above-described step S302 will be described with reference to FIG. 4. For example, referring to FIG. 4, the performance improvement device 500 may calculate a first amount 4100 of water vapor supplied to the humidifier 200 from the outside of the vehicle 10 by multiplying a saturated water vapor amount according to the temperature of the air outside the vehicle 10 by the relative humidity of the air outside the vehicle.

The performance improvement device 500 may calculate a second amount of air vapor supplied from the humidifier using produced water 4200 supplied from the fuel cell stack 100 to the humidifier 200, the humidification efficiency of the humidifier 200, and the total amount of air supplied to the humidifier 200 using Equation 1 below.

$$Second amount of water vapor = \frac{produced water \times humidification efficieny}{total amount of air supplied to humidifier} \qquad [ Equation 1 ]$$

For example, the total amount of air supplied to the humidifier can be calculated by multiplying the theoretical air amount required by the fuel cell stack 100 by the stoichiometric ratio (SR). The theoretical air amount indicates the amount of air theoretically required to produce a certain amount of energy in the fuel cell stack 100, and the stoichiometric ratio (SR) indicates a reference value for correcting the theoretical air amount to the amount of air required for the fuel cell stack 100 to actually produce a certain amount of energy.

The performance improvement device 500 may calculate the current relative humidity 4300 of the fuel cell stack 100 using the first amount of water vapor, the second amount of water vapor, and the saturated water vapor amount according to the current operating temperature of the fuel cell stack 100 using the following Equation 2.

$$Current relative humidity = \frac{first amount of water vapor + second amount of water vapor}{Saturated water vapor amount depending on current operating temperature} \qquad [ Equation 2 ]$$

Referring back to FIG. 3, the performance improvement device 500 may determine the fuel cell stack 100 to be in a dry state if the current relative humidity is below a preset dry relative humidity (Yes in S302). Here, the preset dry relative humidity may be set by multiplying the standard relative humidity by a certain ratio (for example, 0.9).

Also, or alternatively, the performance improvement device 500 may determine whether the battery 300 is expected to be overcharged by comparing expected charging energy to be stored in the battery 300 in a speed limit zone or a congested area and the current charging energy of the battery 300 with the total energy that can be charged in the battery 300 (S303).

For example, the performance improvement device 500 may determine whether the battery 300 is expected to be overcharged in a speed limit zone or a congested area if the vehicle 10 enters the speed limit zone or congested area according to navigation information.

The performance improvement device 500 may calculate energy E_{Stack} produced by the fuel cell stack 100 and driving energy E_{Motor} used by the motor 400 in a speed limit zone or a congested area using the speed limit in the speed limit zone or the congested area and the total driving distance in the speed limit zone or the congested area included in navigation information.

The performance improvement device 500 may calculate expected charging energy E_{Charging} using the produced energy E_{stack} and the driving energy E_{Motor} by Equation 3 below.

$${E}_{Charging} = {E}_{Stack} - {E}_{Motor} \qquad [ Equation 3 ]$$

Referring to FIG. 5, the amount of expected charging energy E_{Charging} stored in the battery 300 may be equal to the amount obtained by subtracting the amount of energy consumed E_{Motor} from the energy E_{stack} produced by the fuel cell stack 100. Energy consumed typically includes the driving energy of a driving motor and also includes the energy used by other accessories, electronic equipment, and an air conditioning device.

The performance improvement device 500 may determine that the battery 300 is expected to be overcharged if the sum of the current charging energy E_{Battery} and the expected charging energy E_{Charging} of the battery 300 is greater than or equal to the total energy E_{Total}, as represented by Equation 4 below (Yes in S303).

$${E}_{Charging} + {E}_{Battery} \geq {E}_{Total} \qquad [ Equation 4 ]$$

For example, referring to FIG. 6, if the operating temperature of the fuel cell stack 100 is first operating temperature>second operating temperature>third operating temperature (T₁>T₂>T₃), first produced energy>second produced energy>third produced energy, and thus the performance improvement device 500 may control the expected charging energy E_{Charging} by adjusting the energy produced by the fuel cell stack 100.

Referring back to FIG. 3, the performance improvement device 500 may switch the driving mode of the vehicle 10 to the durability improvement mode (S304) if the fuel cell stack 100 or the battery 300 satisfies the state condition (Yes in S302 and Yes in S303). The performance improvement device 500 according to an example of the present disclosure may switch the driving mode to the durability improvement mode if both the condition in which the fuel cell stack 100 is in a dry state (Yes in S302) and the condition in which the battery 300 is expected to be overcharged (Yes in S303) are satisfied.

Additionally, or alternatively, the performance improvement device 500 may determine a target operating temperature or a target air flow rate and control the operating temperature of the fuel cell stack 100 or the air flow rate supplied to the fuel cell stack 100 (S305 and S306).

For example, upon determining the dry state and/or the expected overcharge state, the performance improvement device 500 may determine a target operating temperature T_{Target} for the fuel cell stack 100 using the total driving time t_{Drive} of the vehicle 10 in a speed limit zone or a congested area, the current operating temperature T Standard, the total amount of heat Q_{Stack} required to cool the fuel cell stack 100 to the target operating temperature T_{target} in the speed limit zone or the congested area, energy E_{cooling} per unit time required for the coolant circulating through the fuel cell stack 100 to cool the fuel cell stack 100, and heat energy E_{heating} generated from the fuel cell stack 100.

For another example, the performance improvement device 500 may calculate a cooling time t_{cooling} and a heating time t_{heating} of the fuel cell stack 100 using Equations 5 to 8.

$${t}_{cooling} = \frac{{Q}_{stack}}{{E}_{cooling} - {E}_{heating}} \qquad [ Equation 5 ]$$

$${Q}_{stack} = cm Δ t \qquad [ Equation 6 ]$$

$$Δ t = {T}_{standard} - {T}_{target} \qquad [ Equation 7 ]$$

$${t}_{heating} = \frac{{Q}_{stack}}{{E}_{heating}} \qquad [ Equation 8 ]$$

Also, or alternatively, the performance improvement device 500 may derive an optimal target operating temperature at which the sum of the cooling time t_{cooling} and the heating time t_{heating} of the fuel cell stack 100 calculated using the aforementioned Equations is less than or equal to the total driving time.

The performance improvement device 500 may determine a target air flow rate supplied to the fuel cell stack using: the target operating temperature of the fuel cell stack 100, the first amount of water vapor supplied to the humidifier 200, the produced water supplied from the fuel cell stack 100 to the humidifier 200, the humidification efficiency of the humidifier 200, the theoretical air amount, and the preset dry relative humidity.

For example, the performance improvement device 500 may determine the target relative humidity using: the saturated water vapor amount, the first amount of water vapor, the produced water, the humidification efficiency of the humidifier 200, and the theoretical air amount according to the target operating temperature. Additionally, the performance improvement device 500 may determine a target air flow rate at which the determined target relative humidity satisfies the preset dry relative humidity or more.

For example, an Equation obtained by replacing the stoichiometric ratio (SR) in Equation 1 with the target air flow rate, substituting the same into Equation 2, and replacing the saturated water vapor amount depending on the current operating temperature in Equation 2 with the saturated water vapor amount depending on the target operating temperature may be used to determine the target air flow rate that satisfies the preset dry relative humidity or higher.

The performance improvement device 500 may control the operating temperature of the fuel cell stack 100 or the air flow rate supplied to the fuel cell stack 100 depending on the previously determined target operating temperature and target air flow rate.

For example, the performance improvement device 500 may control the operating temperature of the fuel cell stack 100 and the air flow rate supplied to the fuel cell stack 100 by controlling a coolant temperature control valve (CTV) and an air compressor (ACP) of the fuel cell stack 100. However, this is an example and the present disclosure is not necessarily limited thereto.

While controlling the operating temperature or the air flow rate, the performance improvement device 500 may determine whether the state of the fuel cell stack 100 is a flooding state (S307).

For example, the performance improvement device 500 may receive minimum voltages, maximum voltages, and mean voltages of cells included in the fuel cell stack 100.

The performance improvement device 500 may calculate a previous cell deviation Vᵣₐₜᵢₒ standard through the following Equation 9 using a first minimum voltage V₁ₘᵢₙ, a first maximum voltage V₁ₘₐₓ, and a first mean voltage V₁ₘₑₐₙ standard of the cells included in the fuel cell stack 100 before switching to the durability improvement mode.

$${V}_{ratio standard} = \frac{{V}_{1 max} - {V}_{1 min}}{{V}_{1 mean standard}} \qquad [ Equation 9 ]$$

The performance improvement device 500 may calculate the current cell deviation V_{ratio target} through the following Equation 10 using a second minimum voltage V₂ₘᵢₙ, a second maximum voltage V₂ₘₐₓ, and a second mean voltage V₂ₘₑₐₙ target of the cells included in the fuel cell stack 100 after switching to the durability improvement mode.

$${V}_{ratio target} = \frac{{V}_{2 max} - {V}_{2 min}}{{V}_{2 mean target}} \qquad [ Equation 10 ]$$

For example, the performance improvement device 500 may determine the fuel cell stack 100 to be in a flooding state if the following Equation 11 is satisfied using the current operating temperature T_{Standard}, the target operating temperature T_{Target}, the previous cell deviation V_{ratio standard}, and the current cell deviation V_{ratio target} (Yes in S307).

$$\frac{{T}_{standard} - {T}_{target}}{{T}_{standard}} < \frac{{V}_{ratio target}}{{V}_{ratio standard}} \qquad [ Equation 11 ]$$

For example, the performance improvement device 500 may determine that the fuel cell stack 100 is not in a flooding state if the following Equation 12 is satisfied using the current operating temperature T Standard, the target operating temperature T_{Target}, the previous cell deviation V_{ratio standard}, and the current cell deviation V_{ratio target} (No in S307).

$$\frac{{T}_{standard} - {T}_{target}}{{T}_{standard}} > \frac{{V}_{ratio target}}{{V}_{ratio standard}} \qquad [ Equation 12 ]$$

The performance improvement device 500 may cancel the durability improvement mode if the fuel cell stack 100 is in a flooding state (Yes in S307) (S310). For example, if the fuel cell stack 100 is in a flooding state (Yes in S307), the performance improvement device 500 may disable the durability improvement mode such that the target air flow rate is converted to a standard air flow rate.

On the other hand, the performance improvement device 500 may maintain the durability improvement mode if the fuel cell stack 100 is not in a flooding state (No in S307) (S312).

Additionally, the performance improvement device 500 may determine whether the vehicle 10 enters an acceleration situation and whether a time condition is satisfied (S308).

For example, the performance improvement device 500 may determine whether the vehicle 10 enters an acceleration situation depending on whether the expected charging energy E_{Charging} of the battery 300 is less than 0, as represented by Equation 13 below.

$$( {E}_{Charging} = {E}_{Stack} - {E}_{Motor} ) < 0 \qquad [ Equation 13 ]$$

If the expected charging energy E_{Charging} is less than 0, the expected charging energy E_{Charging} of the battery 300 can be converted to discharging energy E Discharging of the battery 300 as represented by Equation 14 below.

$${E}_{Charging} = - {E}_{Discharging} \qquad [ Equation 14 ]$$

If the vehicle 10 enters an acceleration situation (Yes in S308), the performance improvement device 500 may determine a possible driving time of the vehicle 10 based on the current charging energy E_{Battery} of the battery 300 and the expected charging energy (discharging energy E_{Discharging}) of the battery 300. Also, or alternatively, the performance improvement device 500 may disable or maintain the durability improvement mode based on a comparison of (e.g., by comparing) the possible driving time with an expected driving time based on the vehicle 10 entering an acceleration situation (S309).

For example, if the expected driving time is longer than or equal to the possible driving time (Yes in S309), the performance improvement device 500 may determine that accelerated driving upon entering an acceleration situation is impossible with the current charging energy of the battery 300 in the current durability improvement mode state and disable the durability improvement mode (S310).

However, if the expected driving time is less than the possible driving time (No in S309), the performance improvement device 500 may determine that accelerated driving upon entering an acceleration situation is possible with the current charging energy of the battery 300 in the current durability improvement mode state and maintain the durability improvement mode (S312).

For example, the performance improvement device 500 may disable the durability improvement mode and/or switch the driving mode to the normal driving mode if the fuel cell stack 100 is in a flooding state (Yes in S307) and the expected driving time based on the vehicle 10 entering an acceleration situation is longer than or equal to a driving time based on the battery 300 (Yes in S308 and Yes in S309) (S310 and S311). The performance improvement device 500 may disable the durability improvement mode and switch the driving mode to the normal driving mode if the vehicle 10 has exited a speed limit zone or a congested area according to collected navigation information (S310 and S311).

The present disclosure has been made in view of the above problems, and it is an object of the present disclosure to provide technology for controlling an operating temperature or air flow rate of a fuel cell stack by determining a dry state of the fuel cell stack and an expected overcharge state of a vehicle battery while a fuel cell vehicle is traveling in a speed limit zone or a congested area.

The technical objects to be achieved in the present disclosure are not limited to the technical objects mentioned above, and other technical objects that are not mentioned will be clearly understood by those skilled in the art from the description below.

In accordance with an aspect of the present disclosure, the above and other objects can be accomplished by the provision of a method of controlling a fuel cell vehicle, the method including determining whether a fuel cell stack is in a dry state based on relative humidity of supplied air depending on an operating temperature of the fuel cell stack or whether a battery of the vehicle is expected to be overcharged while the vehicle equipped with the fuel cell stack and the battery connected to the fuel cell stack is traveling, and switching a driving mode of the vehicle to a durability improvement mode in which at least one of the operating temperature of the fuel cell stack or an air flow rate supplied to the fuel cell stack is controlled if the fuel cell stack is in a dry state or the battery is expected to be overcharged as a result of the determination.

In accordance with another aspect of the present disclosure, there is provided a fuel cell vehicle including a fuel cell stack, a battery connected to the fuel cell stack, and a performance improvement device configured to determine whether the fuel cell stack is in a dry state based on relative humidity of supplied air depending on an operating temperature of the fuel cell stack or whether the battery is expected to be overcharged while the vehicle is traveling, and to switch a driving mode of the vehicle to a durability improvement mode in which at least one of the operating temperature of the fuel cell stack or an air flow rate supplied to the fuel cell stack is controlled if the fuel cell stack is in a dry state or the battery is expected to be overcharged as a result of the determination.

According to the above, the present disclosure can improve the durability of a fuel cell stack and prevent deterioration of the fuel cell stack by determining a dry state of the fuel cell stack and an expected overcharge state of a vehicle battery during driving in a speed limit zone or a congested area and controlling the operating temperature or air flow rate of the fuel cell stack.

Also, or alternatively, it is possible to obtain the effects of improving durability and preventing deterioration by preemptively controlling the operating temperature or air flow rate of the fuel cell stack at the time of entering or exiting a speed limit zone or a congested area by using navigation information.

Also, or alternatively, by controlling the operating temperature or air flow rate of the fuel cell stack in consideration of the flooding problem of the fuel cell stack, it is possible to prevent deterioration of the performance of a fuel cell vehicle in various manners by taking into account both the dry state and the flooding state of the fuel cell stack.

Also, or alternatively, it is possible to obtain the effects of improving the durability of the fuel cell stack and preventing deterioration of the fuel cell stack by controlling the operating temperature or air flow rate of the stack in consideration of a user's sudden acceleration issue at the time of exiting a speed limit zone or a congested area to prevent sudden power output during low temperature driving and low flow rate driving.

The effects that can be obtained from the present disclosure are not limited to the effects mentioned above, and other effects that area not mentioned can be clearly understood by those skilled in the art from the description below.

Although the present disclosure has been illustrated and described in relation to specific examples, it is apparent in the art that various improvements and changes can be made without departing from the technical spirit of the present disclosure as provided by the following claims.

Furthermore, the term related to a control device such as “controller”, “control apparatus”, “control unit”, “control device”, “control module”, or “server”, etc. refers to a hardware device including a memory and a processor configured to execute one or more steps interpreted as an algorithm structure. The memory stores algorithm steps, and the processor executes the algorithm steps to perform one or more processes of a method in accordance with various exemplary examples of the present disclosure. The control device according to exemplary examples of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured to process data according to a program provided from the memory, and may be configured to generate a control signal according to the processing result.

The control device may be at least one microprocessor operated by a predetermined program which may include a series of commands for carrying out the method included in the aforementioned various exemplary examples of the present disclosure.

The aforementioned disclosure can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc., and implementation as carrier waves (e.g., transmission over the Internet). Examples of the program instruction include machine language code such as those generated by a compiler, as well as high-level language code which may be executed by a computer using an interpreter or the like.

In various exemplary examples of the present disclosure, each operation described above may be performed by a control device, and the control device may be configured by a plurality of control devices, or an integrated single control device.

In various exemplary examples of the present disclosure, the memory and the processor may be provided as one chip, or provided as separate chips.

In various exemplary examples of the present disclosure, the scope of the present disclosure includes software or machine-executable commands (e.g., an operating system, an application, firmware, a program, etc.) for enabling operations according to the methods of various examples to be executed on an apparatus or a computer, a non-transitory computer-readable medium including such software or commands stored thereon and executable on the apparatus or the computer.

In various exemplary examples of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary examples with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary examples of the present disclosure, “at least one of A and B” may refer to “at least one of A or B” or “at least one of combinations of one or more of A and B”. Also, or alternatively, “one or more of A and B” may refer to “one or more of A or B” or “one or more of combinations of one or more of A and B”.

In the exemplary example of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary examples of the present disclosure have been presented for purposes of illustration and description. They are not intended to be exhaustive or to limit the present disclosure to the precise forms disclosed, and obviously many modifications and variations are possible in light of the above teachings. The exemplary examples were chosen and described in order to explain certain principles of the disclosure and their practical application, to enable others skilled in the art to make and utilize various exemplary examples of the present disclosure, as well as various alternatives and modifications thereof. It is intended that the scope of the present disclosure be defined by the Claims appended hereto and their equivalents.

What is claimed is:

1. A method comprising:
while a vehicle, equipped with a fuel cell stack and a battery associated with the fuel cell stack, is traveling, determining, by a control device of the vehicle, one or more of:
that the fuel cell stack is in a dry state based on relative humidity of supplied air depending on an operating temperature of the fuel cell stack, or that the battery associated with the fuel cell stack is expected to be overcharged; and
switching, based on the determining, a driving mode of the vehicle to a durability improvement mode in which at least one of the operating temperature of the fuel cell stack or an air flow rate supplied to the fuel cell stack is controlled to a target value.

2. The method of claim 1, wherein the determining comprises:
receiving navigation information of the vehicle;
determining, based on the navigation information of the vehicle, that the vehicle is entered in a speed limit zone or a congested area; and
determining, while the vehicle is traveling in the speed limit zone or the congested area, that the fuel cell stack is in a dry state or the battery is expected to be overcharged.

3. The method of claim 1, further comprising:
comparing a current relative humidity with a preset dry relative humidity, wherein the current relative humidity is derived from a total amount of water vapor supplied from a humidifier provided in the fuel cell stack and a saturated water vapor amount depending on a current operating temperature of the fuel cell stack,
wherein the determining the fuel cell stack to be in the dry state is based on the current relative humidity being less than or equal to the preset dry relative humidity.

4. The method of claim 3, wherein the current relative humidity is calculated based on:
a first amount of water vapor supplied to the humidifier from outside of the vehicle,
a second amount of water vapor supplied from the humidifier, and
the saturated water vapor amount depending on the current operating temperature.

5. The method of claim 4, wherein the first amount of water vapor is calculated based on:
a saturated water vapor amount, and
a relative humidity of the air outside the vehicle, wherein the saturated water vapor amount depends on a temperature of air outside the vehicle, and
wherein the second amount of water vapor is calculated based on
a produced water supplied from the fuel cell stack to the humidifier,
a humidification efficiency of the humidifier, and
a total amount of air supplied to the humidifier.

6. The method of claim 2, wherein the determining comprises determining that the battery is expected to be overcharged by comparing an expected charging energy to be stored in the battery while the vehicle is in the speed limit zone or the congested area and a current charging energy of the battery with a total energy chargeable in the battery.

7. The method of claim 6, wherein the determining that the battery is expected to be overcharged is based on a sum of the current charging energy and the expected charging energy being greater than or equal to the total energy chargeable in the battery.

8. The method of claim 6, wherein the expected charging energy is calculated based on: energy produced by the fuel cell stack and energy consumed by the vehicle.

9. The method of claim 8, wherein the energy produced by the fuel cell stack and the energy consumed by the vehicle are based on a total traveling distance of the vehicle:
in the speed limit zone at a speed limit of the speed limit zone, or
in the congested area at a speed limit of the congested area, and
wherein the speed limit of the speed limit zone and the speed limit of the congested area are based on the navigation information.

10. The method of claim 1, wherein the switching to the durability improvement mode comprises:
determining a target operating temperature for the fuel cell stack; and
controlling the operating temperature of the fuel cell stack based on the determined target operating temperature.

11. The method of claim 10, wherein the determining the target operating temperature is based on at least one of:
a total driving time for which the vehicle travels in a speed limit zone or a congested area,
a current operating temperature of the fuel cell stack,
a total amount of heat required to cool the fuel cell stack to the target operating temperature in the speed limit zone or a congested area,
energy per unit time required for a coolant circulating through the fuel cell stack to cool the fuel cell stack, or
heat energy generated by the fuel cell stack per unit time.

12. The method of claim 1, wherein the switching to the durability improvement mode comprises:
determining a target air flow rate supplied to the fuel cell stack; and
controlling the air flow rate supplied to the fuel cell stack based on the determined target air flow rate.

13. The method of claim 12, further comprising:
determining a target relative humidity based on at least one of:
a saturated water vapor amount depending on the target operating temperature of the fuel cell stack,
a first amount of water vapor supplied from outside of the vehicle to a humidifier provided in the fuel cell stack,
produced water supplied from the fuel cell stack to the humidifier,
a humidification efficiency of the humidifier, or
theoretical air amount required by the fuel cell stack; and
wherein the determining the target air flow rate supplied to the fuel cell stack comprises determining the target air flow rate to be an air flow rate at which the determined target relative humidity satisfies a preset dry relative humidity.

14. The method of claim 1, further comprising, after the switching to the durability improvement mode:
calculating:
a previous cell deviation with respect to cells in the fuel cell stack before switching to the durability improvement mode, and
a current cell deviation with respect to the cells after switching to the durability improvement mode;
determining whether the fuel cell stack is in a flooding state based on the current operating temperature of the fuel cell stack, the target operating temperature of the fuel cell stack, the previous cell deviation, and the current cell deviation; and
based on the determining whether the fuel cell stack is in the flooding state, disabling or maintaining the durability improvement mode.

15. The method of claim 14, wherein the disabling or maintaining the durability improvement mode comprises:
disabling the durability improvement mode based on the fuel cell stack being in a flooding state; or
maintaining the durability improvement mode based on the fuel cell stack not being in a flooding state.

16. The method of claim 1, further comprising, after the switching to the durability improvement mode:
determining, based on expected charging energy to be stored in the battery being less than 0, that the vehicle has entered an acceleration situation;
determining, based on the expected charging energy and a current charging energy of the battery, a possible driving time of the vehicle; and
based on a result of comparing an expected driving time based on the vehicle entering an acceleration situation with the possible driving time, disabling or maintaining the durability improvement mode.

17. The method of claim 16, wherein the disabling or maintaining the durability improvement mode comprises:
disabling the durability improvement mode based on the expected driving time being longer than or equal to the possible driving time; or
maintaining the durability improvement mode based on the expected driving time being less than the possible driving time.

18. The method of claim 1, further comprising, after the switching to the durability improvement mode:
receiving navigation information of the vehicle; and
disabling the durability improvement mode based on the received navigation information indicating the vehicle having exited a speed limit zone or a congested area.

19. A fuel cell vehicle comprising:
a fuel cell stack;
a battery connected to the fuel cell stack; and
a performance improvement device comprising:
one or more processors; and
memory storing instructions that, when executed by the one or more processors, configure the performance improvement device to:
determine, while the vehicle is traveling, one or more of:
that the fuel cell stack is in a dry state based on relative humidity of supplied air depending on an operating temperature of the fuel cell stack, or
that the battery is expected to be overcharged; and
switch, based on the fuel cell stack being in the dry state or on the battery being expected to be overcharged, a driving mode of the vehicle to a durability improvement mode in which at least one of the operating temperature of the fuel cell stack or an air flow rate supplied to the fuel cell stack is controlled to a target value.
